(19) United States
(12) Patent Application Publication
(10) Pub. No.: US 2018/0290662 A1
(43) Pub. Date: Oct. 11, 2018

(54) METHOD AND DEVICE FOR DETERMINING THE DRIVING BEHAVIOR OF A DRIVER OF A VEHICLE

(71) Applicant: INIT Innovative informatikanwendungen in Transport-, Verkehrs- und Leitsystemen GmBh, Karlsruhe (DE)

(72) Inventors: Christian Decker, Karlsruhe (DE); Simon Anderer, Waldbronn (DE)

(21) Appl. No.: 15/552,837

(22) PCT Filed: Jan. 25, 2016
(86) PCT No.: PCT/DE2016/200034

§ 371 Date: Jun. 18, 2018

(30) Foreign Application Priority Data
Feb. 23, 2015 (DE) 10 2015 203 164.0

(51) Int. Cl. B60W 40/09; B60W 50/16

(52) U.S. Cl. CPC B60W 40/09; B60W 2050/146; B60W 50/16

(57) ABSTRACT

The invention relates to a method for determining the driving behavior of a driver of a vehicle, in particular in urban transport or in inner-city traffic, preferably for use in vehicle fleets, in which at least one parameter describing the driving behavior is determined. Said method is characterized in that the position of the accelerator pedal is determined as a parameter over time. A device for carrying out the method further comprises a sensor system (1).

The invention relates to a method for determining the driving behavior of a driver of a vehicle, in particular in public transportation or in city traffic, preferably for use in vehicle fleets, wherein at least one parameter describing driving behavior is determined. Furthermore, the present invention relates to a device for executing the method.

Methods for determining the driving behavior of a driver of a vehicle have been known for years. In the simplest case, this can be a tachograph. These indicate driving and resting times, driving interruptions, kilometers driven, and the driving speed of the vehicle. The data recorded by the tachographs reflect the driving behavior of the vehicle driver, and are used in particular to monitor compliance with driving and resting times.

Moreover, a method for evaluating driving behavior is known from DE 100 01 261 A1. In order to determine the driving behavior, the current driving state is constantly determined via a driving state determination unit. The vehicle speed, positive or negative vehicle acceleration, distance to a vehicle ahead, and the possible activation of a signal light are recorded as relevant parameters. The driving behavior determined on the basis of these parameters is compared with an optimal driving behavior, such that improvement suggestions can be displayed to the vehicle driver regarding his driving behavior.

Systems of this type are used in vehicle fleets for transport businesses in order to increase driving safety, reduce fuel consumption as well as carbon dioxide emissions, and to reduce wear to the vehicle.

With the systems known from the prior art, it is problematic that they are extremely expensive, due to the complicated sensor technology. Another substantial disadvantage is that these systems are not suitable for determining the driving behavior of a vehicle driver driving public transportation or in city traffic. Travel in public transport is distinguished by very short driving intervals, specifically between two stops. Due to traffic situations in urban areas, which involve pedestrians and quick lane changes in a continuous traffic flow, repeated acceleration and braking takes place in such a form of travel in short intervals. The parameters for determining the driving behavior known from the prior art are not suited to such a traffic situation.

The object of the present invention is therefore to design and develop a method for determining the driving behavior of a driver of a vehicle such that the driving behavior can be determined in arbitrary traffic situations with simple means. Moreover, a corresponding device is also to be specified.

In accordance with the invention, the aforementioned objective is achieved through the features of Claim 1. Accordingly, the method for determining the driving behavior of a driver of a vehicle is characterized in that the position of the gas pedal is determined over the course of time as a parameter.

In an inventive manner, it has been acknowledged that the fundamental objective can be achieved in a clever and simple manner through the determination of the position of the gas pedal, because this, so far disregarded, parameter reflects the driving behavior of the driver of the vehicle. Moreover, it has been determined that this parameter describes the driving behavior in an ideal manner, particularly in very short stop-and-go driving conditions, such as those encountered in public transportation or city traffic. For this, the position of the gas pedal is determined over the course of time, e.g. over the course of the entire drive. A further advantage of the method according to the invention is that the position of the gas pedal can be detected very easily. It has also been acknowledged that simply by determining the position of the gas pedal, a sufficient quantity of information is obtained regarding the driving behavior to be able to describe said driving behavior.

In an advantageous manner, the fuel consumption can be determined over time as a further parameter. In this manner, a further substantial variable is delineated, such that it is also possible to make determinations regarding fuel conservation. At this point it is expressly noted that the term “fuel” is to be understood in the broadest sense, specifically as any type of energy source that may be provided for a vehicle. This can be gasoline, diesel, electricity, hydrogen, etc.

In order to obtain detailed information regarding the actuation of the gas pedal, the change in position of the gas pedal over time can be determined as a further parameter. This can take place via an appropriate sensor, for example. If the position of the gas pedal as a function of time is available, the change in the position of the gas pedal can also be determined through the derivation of this function, such that only the position of the gas pedal over the course of time needs to be recorded.

In order to enable a more precise determination of the driving behavior, further parameters can be determined. These can be, e.g., the position of the vehicle and/or the speed of the vehicle and/or the acceleration of the vehicle and/or the current weather conditions and/or the current traffic conditions and/or the distance to a neighboring vehicle, in particular a vehicle that is in front.

In order to enable a reliable determination of the driving behavior with as little effort as possible, the parameters can be detected via a suitable sensor technology on the vehicle. In a particularly advantageous manner, a sensor technology for determining the position of the gas pedal over time can be used, e.g. an inductive or capacitive movement and/or distance sensor.

For evaluating the parameters, the data can be stored in a memory of the vehicle. By way of example, the data can be stored in a relational database management system (RDBMS). As a result, these data can be processed in an ideal manner, e.g. via SQL queries. The processing of this data can be carried out thereby in a computing unit disposed in the vehicle.

It is furthermore conceivable that the data described above are transmitted to a central computer and stored there. The transmission ideally takes place in a wireless manner, e.g. via a cellular network or a WLAN. The data can be stored in the central computer in an RDBMS. It is furthermore conceivable that the data are processed by the central computer, specifically in order to depict or analyze the driving behavior of the vehicle driver.

In a particularly advantageous manner, the determined parameters can be set in relation to one another. For this, the determined fuel consumption over time and the determined position of the gas pedal over time can be set in relation to one another. On the basis of this, improvement suggestions for fuel conservation can be proposed to the driver.

In a particularly clever manner, it is furthermore conceivable that the driver of the vehicle is identified on the basis of the determined parameters. It has been determined thereby that it is possible to identify the driver in a surprisingly simple manner by evaluating the data concerning the position of the gas pedal. In concrete terms, the recorded data can be compared with existing data. The existing data can be data regarding the position of the gas pedal over time that have been assigned to a specific vehicle driver. If the recorded data conform to the existing data, then the vehicle driver can be clearly identified. A conformity can also be merely in defined, characteristic fields that are particularly suited for identification.

In order to implement an evaluation of the driving behavior, the determined actual value of a parameter, e.g. the position of the gas pedal, can be compared with a target value for this parameter. An ideal value of the parameter can be made available as the target value by taking into account, for example, a specific route and, optionally, taking into account the current traffic situation and/or the current weather conditions. In order to improve the driving behavior, it is then possible to indicate to the driver, via an acoustic and/or visual and/or haptic indicator, when the actual value corresponds to the target value and/or when the actual value deviates from the target value. As a result, the vehicle driver receives an ideal “feedback” at all times regarding his current driving behavior, and can modify this behavior in order to make improvements.

The present invention is defined by the features of Claim 13 with respect to a device according to the invention. Accordingly, a device for executing the method according to any of the Claims 1 to 12 is specified, wherein the device comprises a sensor system for monitoring the position of the gas pedal. As a result, an execution of the method according to the invention is implemented with very little instrumental effort.

Moreover, it should be noted that the features concerning the method according to the invention specified above can also be embodied in accordance with the device. A combination of these features with the features concerning the device Claims is not only possible, but advantageous.

There are thus various possibilities for embodying and developing the teachings of the present invention in an advantageous manner. Reference is made hereby, on one hand, to the Claims dependent on Claim 1, and on the other hand, to the following explanations of preferred exemplary embodiments of the invention based on the drawings. Generally preferred embodiments and developments of the teachings shall also be explained in general in conjunction with the explanations of the preferred exemplary embodiments of the invention based on the drawings. Therein:

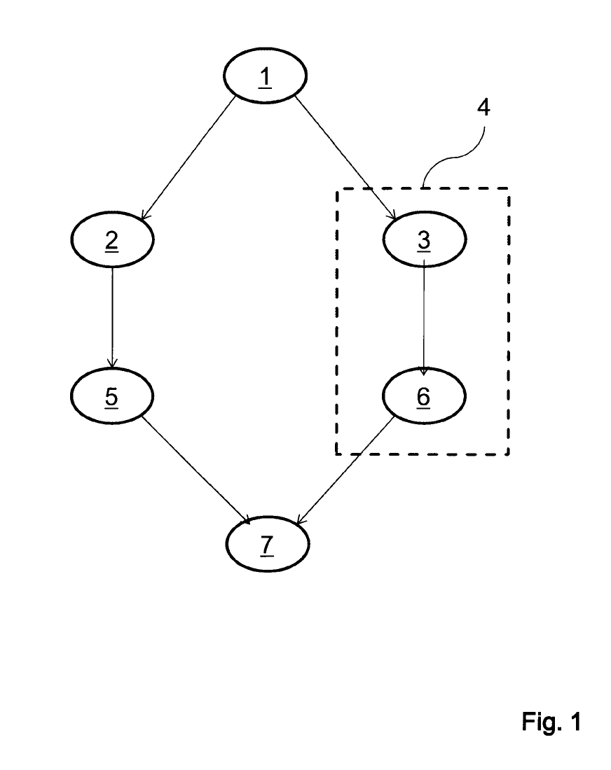

FIG. 1 shows, in a schematic view, a flow chart for an exemplary embodiment of the method according to the invention,

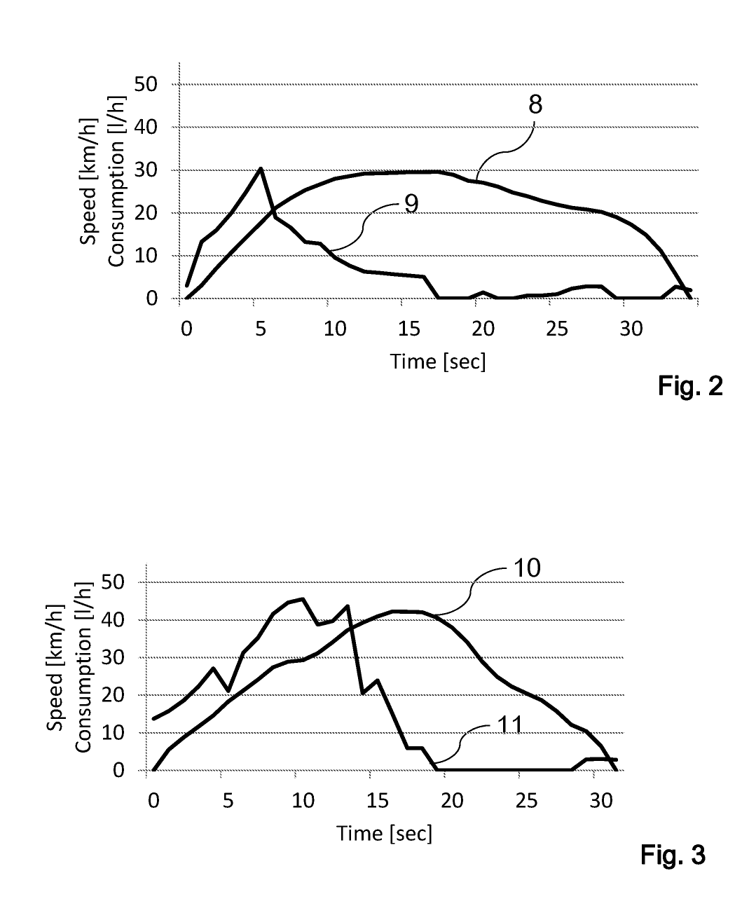

FIG. 2 shows the speed determined over time, as well as the fuel consumption determined over time, of a first vehicle driver,

FIG. 3 shows the speed determined over time, as well as the fuel consumption determined over time, of a second vehicle driver,

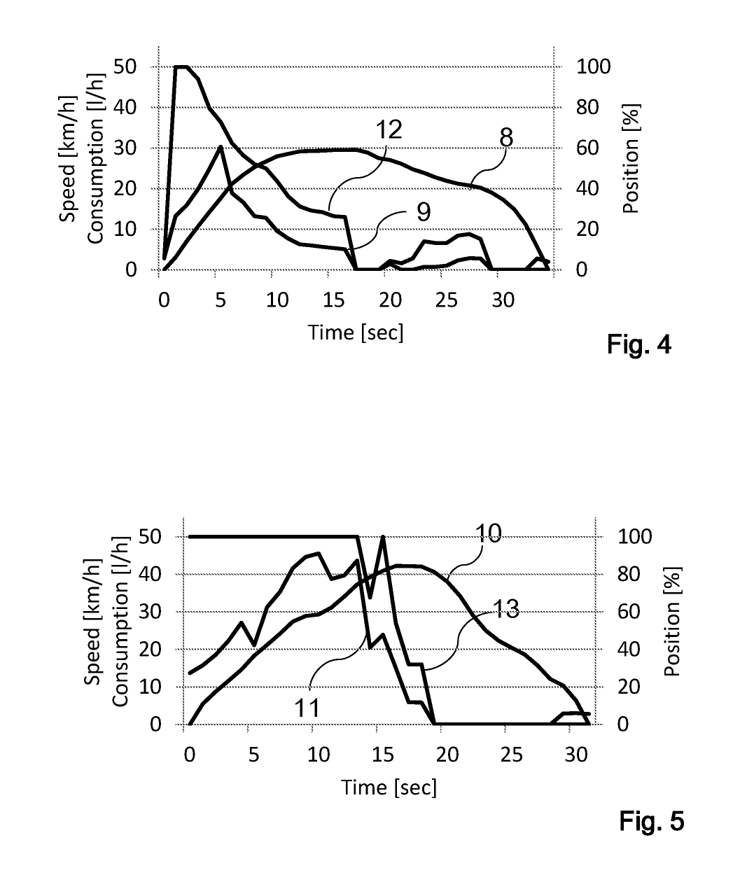

FIG. 4 shows the graph according to FIG. 2, wherein the position of the gas pedal determined over time is also plotted,

FIG. 5 shows the graph according to FIG. 3, wherein the position of the gas pedal determined over time is also plotted,

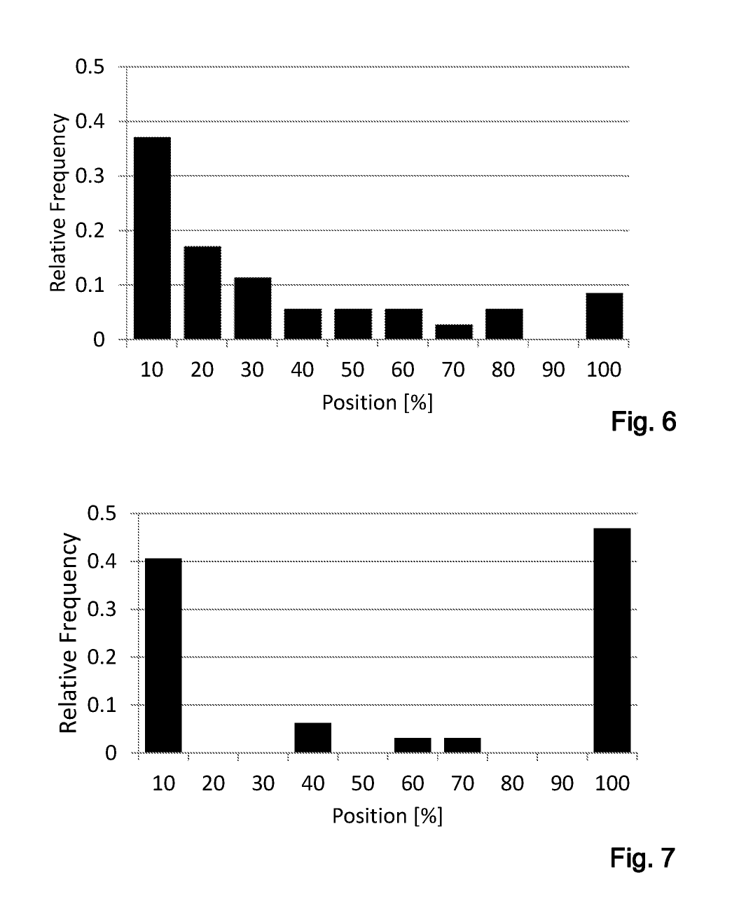

FIG. 6 shows the distribution of the relative frequencies of the different extents of actuations of the gas pedal for the curve in FIG. 4,

FIG. 7 shows the distribution of the relative frequencies of the different extents of actuations of the gas pedal for the curve in FIG. 5.

FIG. 1 shows, in a schematic illustration, a flow chart of an exemplary embodiment of the method according to the invention. First, the position of the gas pedal is continuously detected by a sensor system 1 over time. Moreover, in addition to the position of the gas pedal, other parameters can also be detected by the sensor system 1 or another sensor system, based on which it is possible to determine the driving behavior of the vehicle driver. The data detected by the sensor system 1 are stored in a memory 2 of the vehicle and/or transmitted to a memory 3 of a central computer 4. The transmission can preferably take place in a wireless manner—via a cellular network or WLAN—and in real time.

The data stored in the database 2 can be processed by a computing unit 5, preferably disposed in the vehicle. In the same manner, the data stored in the database 3 can be processed by a computing unit 6 of the central computer 4. The processing takes place thereby such that the driving behavior of the vehicle driver is determined from the data, wherein, alternatively or additionally, the vehicle driver is identified on the basis of the recorded data.

The processed data can be displayed by a display 7 disposed in the motor vehicle. The display 7 can indicate to the vehicle driver whether his driving behavior corresponds to a desired driving behavior, e.g. with respect to fuel consumption and/or the prevention of accidents. It is furthermore conceivable that the processed data are displayed in an external display, e.g. in the framework of a training exercise.

FIG. 2 shows the speed determined over time, as well as fuel consumption determined over time, of a first vehicle driver. For this, in a first curve 8, the speed is plotted in km/h over time tin seconds, and in a second curve 9, the fuel consumption is plotted in l/h over time t in seconds.

It is clear from FIG. 2 that this is the typical course of a stop-and-go driving situation, such as occurs between two stops on a bus route. This is characterized by a relative short overall travel time of only ca. 35 seconds, in which the vehicle is first strongly accelerated to ca. 30 km/h, wherein this speed is maintained for only ca. 8 seconds, and then the vehicle decelerates in order to subsequently stop at the next bus stop. In the graph shown in FIG. 2, the fuel consumption for this drive is ca. 0.064 liters.

FIG. 3 shows the speed determined over time, as well as the fuel consumption determined over time, of a second vehicle driver, wherein the route is identical to the first route that is the basis for FIG. 2. For this, the speed is plotted in a third curve 10 in km/h over time tin seconds, and the fuel consumption is plotted in a fourth curve 11 in l/h over time tin seconds.

The driving time required by the second driver is negligibly shorter than the driving time depicted in FIG. 2, and is specifically 32 seconds. It is important thereby that the first curve 8 and the third curve 10 deviate from one another only slightly, and in particular in the range between 0 seconds and 8 seconds they substantially correspond to one another.

However, the fuel consumption in FIG. 3 is ca. twice that in FIG. 2, and is specifically ca. 0.144 liters for this drive. It is clear from the comparison of FIGS. 2 and 3 that the speed determined over time in stop-and-go driving is not suitable as a parameter for determining the driving behavior.

FIG. 4 shows the graph pursuant to FIG. 2, wherein the position of the gas pedal over time is plotted as an additional fifth curve 12. The position of the gas pedal is given in percentages, wherein 100% corresponds to a full actuation of the gas pedal, and 0% corresponds to a fully un-actuated gas pedal.

FIG. 5 shows the graph pursuant to FIG. 3, wherein here as well, the position of the gas pedal determined over time is additionally plotted as a sixth curve 13.

The comparison of the fifth curve 12 from FIG. 4 and the sixth curve 13 from FIG. 5 shows that these positions deviate significantly over the overall time, in particular in the range between 0 seconds and 8 seconds as well. As a result, it is clear that the position of the gas pedal over time is ideally suited as a parameter for determining the driving behavior.

FIG. 6 shows the distribution of the relative frequencies of the different extents of the actuation of the gas pedal for the fifth curve 12 shown in FIG. 4. FIG. 7 shows the distribution of the relative frequencies of the different extents of the actuation of the gas pedal for the sixth curve 13 shown in FIG. 5.

The comparison of FIGS. 6 and 7 clearly indicates that the first vehicle driver and the second vehicle driver actuate the gas pedal extremely differently, wherein specifically, the second vehicle driver, pursuant to FIG. 7, fully actuates the gas pedal significantly more frequently, i.e. he fully “steps on it.” Based on FIGS. 6 and 7, the different driving behaviors of the first vehicle driver and the second vehicle driver is very clearly visible. As a result, it is shown that the position of the gas pedal over time is ideally suited as a parameter for determining the driving behavior. Furthermore, the position of the gas pedal can be detected by an extremely simple sensor system.

With respect to further advantageous designs of the method according to the invention, and the device according to the invention, reference is made to the general part of the description and to the attached Claims, in order to avoid repetition.

Lastly, it is expressly noted that the exemplary embodiments of the method according to the invention and the device according to the invention described above serve only for explanations of the teachings claimed herein, but these teachings are not limited to the exemplary embodiments.

### LIST OF REFERENCE SYMBOLS

1 sensor system
2 memory (internal)
3 memory (external)
4 central computer
5 computing unit
6 computing unit (external)
7 display
8 first curve
9 second curve
10 third curve
11 fourth curve
12 fifth curve
13 sixth curve

### Key to the Drawings:

Page 2/4:

Geschwindigkeit: speed

Verbrauch: consumption

Zeit: time

Page 3/4:

Geschwindigkeit: speed

Verbrauch: consumption

Zeit: time

Stellung: position

Page 4/4

rel. Häufigkeit: relative frequency

Stellung: position

1. A method for determining a driving behavior of a driver of a vehicle, in particular in public transportation or in city traffic, preferably for use in vehicle fleets, wherein at least one parameter describing the driving behavior is determined, characterized in that the position of the gas pedal is determined over time as the parameter.

2. The method according to claim 1, characterized in that the fuel consumption is determined over time as a further parameter.

3. The method according to claim 1, characterized in that the change in the position of the gas pedal is determined over time as a further parameter.

4. The method according to claim 1, characterized in that the position of the vehicle and/or the speed of the vehicle and/or the acceleration of the vehicle and/or the current weather conditions and/or the current traffic conditions and/or the distance to a neighboring vehicle are determined as further parameters.

5. The method according to claim 1, characterized in that the parameter, in particular the position of the gas pedal, is detected via a sensor system (1) in the vehicle.

6. The method according to claim 1, characterized in that data corresponding to the determined parameters is stored in a memory (2) of the vehicle, and if applicable, processed by a computing unit (5).

7. The method according to claim 1, characterized in that data corresponding to the determined parameters is transmitted, preferably in a wireless manner, to a central computer (4), and if applicable, processed by the central computer (4).

8. The method according to claim 1, characterized in that the determined parameters are set in relation to one another.

9. The method according to claim 3, characterized in that the determined fuel consumption and the determined position of the gas pedal are set in relation to one another.

10. The method according to claim 1, characterized in that the vehicle driver is identified on the basis of the determined parameters, in particular on the basis of the determined position of the gas pedal.

11. The method according to claim 1, characterized in that the determined actual value of a parameter, in particular the position of the gas pedal, is compared with a target value for this parameter.

12. The method according to claim 11, characterized in that it is indicated to the vehicle driver, via an acoustic and/or visual and/or haptic display (7), when the actual value corresponds to the target value and/or when the actual value deviates from the target value.

13. A device for executing the method according to claim 1, comprising a sensor system (1) for monitoring the position of the gas pedal.
